(19) United States
(12) Patent Application Publication
(10) Pub. No.: US 2011/0163948 A1
(43) Pub. Date: Jul. 7, 2011

(54) METHOD SYSTEM AND SOFTWARE FOR PROVIDING IMAGE SENSOR BASED HUMAN MACHINE INTERFACING

(76) Inventors: Dor Givon, Rishon-Lezion (IL); Ofer Sadka, Ramat Gan (IL); Ilya Kottel, Bat-Yam (IL); Igor Bunimovich, Netanya (IL)

(21) Appl. No.: 13/061,568

(22) PCT Filed: Sep. 6, 2009
(86) PCT No.: PCT/IL09/00862

§ 371 Date: Mar. 1, 2011

Related U.S. Application Data
(60) Provisional application No. 61/094,078, filed on Sep. 4, 2008.

(51) Int. Cl. G09G 5/00

(52) U.S. Cl. 345/156

(57) ABSTRACT

Disclosed is a method system and associated modules and software components for providing image sensor based human machine interfacing (“IBHMI”). According to some embodiments of the present invention, output of an IBHMI may be converted into an output string or into a digital output command based on a first mapping table. An IBHMI mapping module may receive one or more outputs from an IBHMI and may reference a first mapping table when generating a string or command for a first application running the same or another functionally associated computing platform. The mapping module may emulate a keyboard, a mouse, a joystick, a touchpad or any other interface device compatible, suitable or congruous with the computing platform on which the first application is running.

### FIELD OF THE INVENTION

The present invention relates generally to the field of human machine interfaces. More specifically, the present invention relates to methods systems and associated modules and software components for providing image sensor based human machine interfacing.

### BACKGROUND

One of the largest patterns in the history of software is the shift from computation-intensive design to presentation-intensive design. As machines have become more and more powerful, inventors have spent a steadily increasing fraction of that power on presentation. The history of that progression can be conveniently broken into three eras: batch (1945-1968), command-line (1969-1983) and graphical (1984 and after). The story begins, of course, with the invention of the digital computer. The opening dates on the latter two eras are the years when vital new interface technologies broke out of the laboratory and began to transform users' expectations about interfaces in a serious way. Those technologies were interactive timesharing and the graphical user interface.

In the batch era, computing power was extremely scarce and expensive. The largest computers of that time commanded fewer logic cycles per second than a typical toaster or microwave oven does today, and quite a bit fewer than today's cars, digital watches, or cell phones. User interfaces were, accordingly, rudimentary. Users had to accommodate computers rather than the other way around; user interfaces were considered overhead, and software was designed to keep the processor at maximum utilization with as little overhead as possible.

The input side of the user interfaces for batch machines were mainly punched cards or equivalent media like paper tape. The output side added line printers to these media. With the limited exception of the system operator's console, human beings did not interact with batch machines in real time at all.

Submitting a job to a batch machine involved, first, preparing a deck of punched cards describing a program and a dataset. Punching the program cards wasn't done on the computer itself, but on specialized typewriter-like machines that were notoriously balky, unforgiving, and prone to mechanical failure. The software interface was similarly unforgiving, with very strict syntaxes meant to be parsed by the smallest possible compilers and interpreters.

Once the cards were punched, one would drop them in a job queue and wait. Eventually, operators would feed the deck to the computer, perhaps mounting magnetic tapes to supply another dataset or helper software. The job would generate a printout, containing final results or (all too often) an abort notice with an attached error log. Successful runs might also write a result on magnetic tape or generate some data cards to be used in later computation.

The turnaround time for a single job often spanned entire days. If one were very lucky, it might be hours; real-time response was unheard of. But there were worse fates than the card queue; some computers actually required an even more tedious and error-prone process of toggling in programs in binary code using console switches. The very earliest machines actually had to be partly rewired to incorporated program logic into themselves, using devices known as plugboards.

Early batch systems gave the currently running job the entire computer; program decks and tapes had to include what we would now think of as operating-system code to talk to I/O devices and do whatever other housekeeping was needed. Midway through the batch period, after 1957, various groups began to experiment with so-called “load-and-go” systems. These used a monitor program which was always resident on the computer. Programs could call the monitor for services. Another function of the monitor was to do better error checking on submitted jobs, catching errors earlier and more intelligently and generating more useful feedback to the users. Thus, monitors represented a first step towards both operating systems and explicitly designed user interfaces.

Command-line interfaces (CLIs) evolved from batch monitors connected to the system console. Their interaction model was a series of request-response transactions, with requests expressed as textual commands in a specialized vocabulary. Latency was far lower than for batch systems, dropping from days or hours to seconds. Accordingly, command-line systems allowed the user to change his or her mind about later stages of the transaction in response to real-time or near-real-time feedback on earlier results. Software could be exploratory and interactive in ways not possible before. But these interfaces still placed a relatively heavy mnemonic load on the user, requiring a serious investment of effort and learning time to master.

Command-line interfaces were closely associated with the rise of timesharing computers. The concept of timesharing dates back to the 1950s; the most influential early experiment was the MULTICS operating system after 1965; and by far the most influential of present-day command-line interfaces is that of Unix itself, which dates from 1969 and has exerted a shaping influence on most of what came after it.

The earliest command-line systems combined teletypes with computers, adapting a mature technology that had proven effective for mediating the transfer of information over wires between human beings. Teletypes had originally been invented as devices for automatic telegraph transmission and reception; they had a history going back to 1902 and had already become well-established in newsrooms and elsewhere by 1920. In reusing them, economy was certainly a consideration, but psychology and the Rule of Least Surprise mattered as well; teletypes provided a point of interface with the system that was familiar to many engineers and users.

The widespread adoption of video-display terminals (VDTs) in the mid-1970s ushered in the second phase of command-line systems. These cut latency further, because characters could be thrown on the phosphor dots of a screen more quickly than a printer head or carriage can move. They helped quell conservative resistance to interactive programming by cutting ink and paper consumables out of the cost picture, and were to the first TV generation of the late 1950s and 60s even more iconic and comfortable than teletypes had been to the computer pioneers of the 1940s.

Just as importantly, the existence of an accessible screen, a two-dimensional display of text that could be rapidly and reversibly modified made it economical for software designers to deploy interfaces that could be described as visual rather than textual. The pioneering applications of this kind were computer games and text editors; close descendants of some of the earliest specimens, such as rogue (6), and VI (1), are still a live part of UNIX tradition.

Screen video displays were not entirely novel, having appeared on minicomputers as early as the PDP-1 back in 1961. But until the move to VDTs attached via serial cables, each exceedingly expensive computer could support only one addressable display, on its console. Under those conditions it was difficult for any tradition of visual UI to develop; such interfaces were one-offs built only in the rare circumstances where entire computers could be at least temporarily devoted to serving a single user.

There were sporadic experiments with what we would now call a graphical user interface as far back as 1962 and the pioneering SPACEWAR game on the PDP-1. The display on that machine was not just a character terminal, but a modified oscilloscope that could be made to support vector graphics. The SPACEWAR interface, though mainly using toggle switches, also featured the first crude trackballs, custom-built by the players themselves. Ten years later, in the early 1970s these experiments spawned the video-game industry, which actually began with an attempt to produce an arcade version of SPACEWAR.

The PDP-1 console display had been descended from the radar display tubes of World War II, twenty years earlier, reflecting the fact that some key pioneers of minicomputing at MIT's Lincoln Labs were former radar technicians. Across the continent in that same year of 1962, another former radar technician was beginning to blaze a different trail at Stanford Research Institute. His name was Doug Engelbart. He had been inspired by both his personal experiences with these very early graphical displays and by Vannevar Bush's seminal essay As We May Think, which had presented in 1945 a vision of what we would today call hypertext.

In December 1968, Engelbart and his team from SRI gave a 90-minute public demonstration of the first hypertext system, NLS/Augment.[9] The demonstration included the debut of the three-button mouse (Engelbart's invention), graphical displays with a multiple-window interface, hyperlinks, and on-screen video conferencing. This demo was a sensation with consequences that would reverberate through computer science for a quarter century, up to and including the invention of the World Wide Web in 1991.

So, as early as the 1960s it was already well understood that graphical presentation could make for a compelling user experience. Pointing devices equivalent to the mouse had already been invented, and many mainframes of the later 1960s had display capabilities comparable to those of the PDP-1. One of your authors retains vivid memories of playing another very early video game in 1968, on the console of a Univac 1108 mainframe that would cost nearly forty-five million dollars if you could buy it today in 2004. But at $45M a throw, there were very few actual customers for interactive graphics. The custom hardware of the NLS/Augment system, while less expensive, was still prohibitive for general use. Even the PDP1, costing a hundred thousand dollars, was too expensive a machine on which to found a tradition of graphical programming.

Video games became mass-market devices earlier than computers because they ran hardwired programs on extremely cheap and simple processors. But on general-purpose computers, oscilloscope displays became an evolutionary dead end. The concept of using graphical, visual interfaces for normal interaction with a computer had to wait a few years and was actually ushered in by advanced graphics-capable versions of the serial-line character VDT in the late 1970s.

Since the earliest PARC systems in the 1970s, the design of GUIs has been almost completely dominated by what has come to be called the WIMP (Windows, Icons, Mice, Pointer) model pioneered by the Alto. Considering the immense changes, is in computing and display hardware over the ensuing decades, it has proven surprisingly difficult to think beyond the WIMP.

A few attempts have been made. Perhaps the boldest is in VR (virtual reality) interfaces, in which users move around and gesture within immersive graphical 3-D environments. VR has attracted a large research community since the mid-1980s. While the computing power to support these is no longer expensive, the physical display devices still price VR out of general use in 2004. A more fundamental problem, familiar for many years to designers of flight simulators, is the way VR can confuse the human proprioceptive system; VR motion at even moderate speeds can induce dizziness and nausea as the brain tries to reconcile the visual simulation of motion with the inner ear's report of the body's real-world motions.

Jef Raskin's THE project (The Humane Environment) is exploring the zoom world model of GUIs, described in that spatializes them without going 3D. In THI the screen becomes a window on a 2-D virtual world where data and programs are organized by spatial locality. Objects in the world can be presented at several levels of detail depending on one's height above the reference plane, and the most basic selection operation is to zoom in and land on them.

The Lifestreams project at Yale University goes in a completely opposite direction, actually de-spatializing the GUI. The user's documents are presented as a kind of world-line or temporal stream which is organized by modification date and can be filtered in various ways.

All three of these approaches discard conventional file systems in favor of a context that tries to avoid naming things and using names as the main form of reference. This makes them difficult to match with the file systems and hierarchical namespaces of UNIX's architecture, which seems to be one of its most enduring and effective features. Nevertheless, it is possible that one of these early experiments may yet prove as seminal as Engelhard's 1968 demo of NLS/Augment.

There is a need in the field of user interfaces for an improved system and method of a Human-Machine-Interface.

### SUMMARY OF THE INVENTION

The present invention is a method system and associated modules and software components for providing image sensor based human machine interfacing. According to some embodiments of the present invention, output of an IBHMI may be converted into an output string or into a digital output command based on a first mapping table. An IBHMI mapping module may receive one or more outputs from an IBHMI and may reference a first mapping table when generating a string or command for a first application running the same or another functionally associated computing platform. The mapping module may emulate a keyboard, a mouse, a joystick, a touchpad or any other interface device compatible, suitable or congruous with the computing platform on which the first application is running. According to some embodiments of the present invention, the IBHMI, the mapping module and the first application may be running on the same computing platform. According to further embodiments of the present invention, the IBHMI, the mapping module and the first application may be integrated into a single application or project.

According to some embodiments of the present invention, the first mapping table may be part of a discrete data table to which the mapping module has access, or the mapping table may be integral with (e.g. included with the object code) the mapping module itself. The first mapping table may be associated with a first application, such that a first output of the IBHMI, associated with the detection of a motion of position of first motion/position type (e.g. raising of the right arm), may be received by the mapping module and may be mapped in a first input command (e.g. scroll right) provided to the first application. According to the first mapping table, a second output of the IBHMI, associated with the detection of a motion or position of a second motion/position type (e.g. raising of the left arm), may be received by the mapping module and may be mapped into a second input command (e.g. scroll left) provided to the first application. The mapping table may include a mapping record for some or all of the possible outputs of the IBHMI. The mapping table may include a mapping record for some or all of the possible input strings or commands of the first application. The mapping table may be stored on non-volatile memory or may reside in the operating memory of a computing platform. The mapping table may be part of a configuration or profile file.

According to yet further embodiments of the present invention, the mapping module may access a second mapping table which second table may be associated with either the first application or possibly with a second or third application. The second mapping table may include one or more mapping records, some of which mapping records may be the same as correspond records in the first mapping table and some records may be different from corresponding records in the first mapping table. Accordingly, when the mapping module is using the second mapping table, some or all of the same IBHMI outputs may result in different output strings or commands being generated by mapping module.

According to yet further embodiments of the present invention, there is provided an IBHMI mapping table generator. The table generator may receive a given output from an IBHMI and may provide a user with one or more options regarding which output string or command to associate with the given IBHMI output. The given output may be generated by the IBHMI in response to a motion/position of a given type being detected in an image (e.g. video) acquired from an image sensor. The given output may be generated by the IBHMI in response to a motion/position of a given type being detected in an image/video file. According to yet further embodiments of the present invention, the mapping table generator may have stored some or all of the possible IBHMI outputs, including a graphic representation of the detected motion/position type associated with each output. A graphical user interface of the generator may provide a user with a (optionally: computer generated) representation of a given motion/position type and an option to select an output string/command to map or otherwise associate (e.g. bind) with the given motion/position type.

According to further embodiments of the present invention, a graphic interface comprising a human model may be used for the correlation phase. By motioning/moving the graphic model (using available input means), the user may be able to choose the captured motions (e.g. positions, movements, gestures or lack of such) to be correlated to the computer events (e.g. a computerized-system-or applications' possible input signals)—motions to be later mimicked by the user (e.g. using the user's body). Alternatively, motions to be captures and correlated may be optically, vocally or otherwise obtained, recorded and/or defined.

Furthermore, a code may be produced, to be used by other applications for access and use (e.g. through graphic interface, SDK API) of the captured motion to computer events—Correlation Module—for creating/developing correlation/profiles for later use by these other applications and their own users.

Sets of correlations may be grouped into profiles, whereas a profile may comprise a set of correlations relating to each other (e.g. correlations to all computer events needed for initiation and/or control of a certain computerized application). For example: One or more users may “build” one or more movement profiled for any given computerized-system-or-application. This may be done for correlating multiple sets of different (or partially different) body movements, to the same list of possible input signals or commands which control a given computerized-system-or-application.

According to some embodiments of the present invention, once a given profile is complete (i.e. motions for all necessary computer events were defined) a user may start using these motions (e.g. his body movements) for execution of said computer events. Hence, controlling a computerized-system-or-application, profiled by user's own definitions. Users may be able to create profiles for their own use or for other users.

Once correlated, execution of captured motions may be used to initiate and/or control the computer events. Whereas execution of a certain, captured and correlated motion may trigger a corresponding computer event such as, but not limited to, an application executable command (e.g. commands previously assigned to keyboard, mouse or joystick actions).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram showing a signal converting module;

FIG. 2 is a block diagram showing a signal converting system;

FIGS. 3A & 3B are semi-pictorial diagrams depicting execution phases of two separate embodiments of a IBHMI signal converting system;

FIGS. 4A & 4B are a semi-pictorial diagrams depicting a two separate development phases of a signal converting system;

FIGS. 5A, 5B and 5C are each flows charts including the steps of a mapping table generator execution flow;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

[Claims Converted to English]

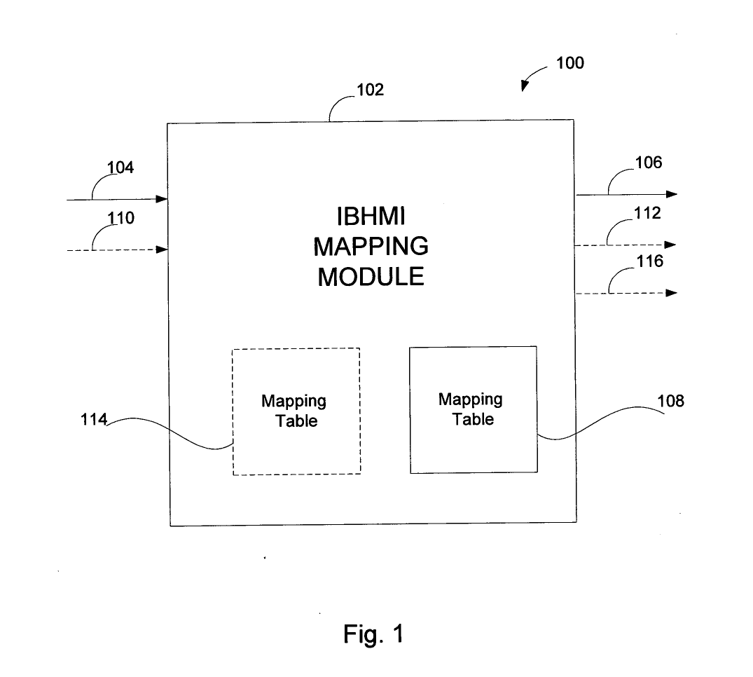

Turning now to FIG. 1, there is shown a signal converting element such as signal converting module 100. Signal converting module 100 may convert an output string into a digital output command. Signal converting module 100 is further comprised of a mapping module such as mapping module 102 which may convert, transform or modify a first signal associated with captured motion such as captured motion output 104 and convert it into a second signal associated with a first application such as application command 106. Captured motion output may be a video stream, a graphic file, a multimedia signal and more but not limited to these examples. An application may be a computer game, a console game, a console apparatus, an operating system and more but not limited to these examples.

According to some embodiments of the present invention, mapping module 102 may emulate a keyboard, a mouse, a joystick, a touchpad or any other interface device compatible with a computing platform on which the first application is running.

According to some embodiments of the present invention, a first mapping table such as mapping table 108 may be part of a discrete data table to which mapping module 102 has access, or mapping table 108 may be integral with mapping module 102 itself, for example if the mapping table is included with the object code. Mapping table 108 may be associated with a first application, such that a captured motion output 104, associated with the detection of a motion of position of first motion/position type (e.g. raising of the right arm), may be received by mapping module 102 and may be mapped into input command 106 (e.g. scroll right) provided to a first application. According to mapping table 108, captured motion output 110, which may be associated with the detection of a motion or position of a second motion/position type (e.g. raising of the left arm), may be received by mapping module 102 and may be mapped into application command 112 (e.g. scroll left) provided to a first application. Mapping table 108 may include a mapping record for some or all of the captured motion outputs such as captured motion output 104 and 110. The mapping table may include a mapping record for some or all of the possible input strings or commands of a first application such as application command 106 and 112.

According to yet further embodiments of the present invention, mapping module 102 may access a second mapping table such as mapping table 114 which may be associated with either the first application or possibly with a second or third application. Mapping table 114 may include one or more mapping records, some of which mapping records may be the same as correspond records in mapping table 108 and some records, data files or image files may be different from corresponding records in mapping table 108. Accordingly, when mapping module 102 is using mapping table 114, captured motion 110 may result in application command 116 while captured motion output 104 may result in application command 106 (which corresponds with the same result as when using mapping table 108). Mapping records may be part of discrete data files such as configuration files or profile files. The mapping records may be integral with executable code, such as an IBHMI API or with the first or second applications.

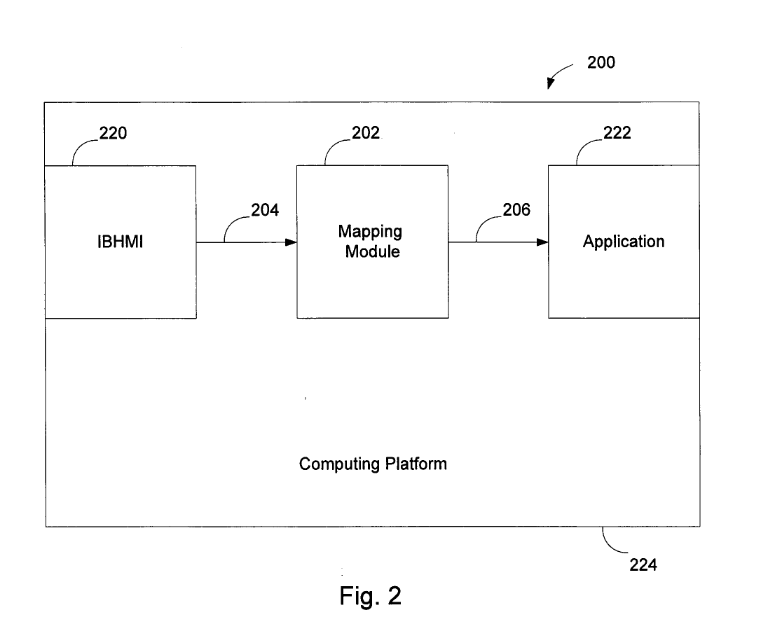

Turning now to FIG. 2, there is shown a signal converting system such as signal converting system 200. Signal converting system 200 may be comprised of a mapping module such as mapping module 202 which may convert a first signal associated with captured motion such as captured motion output 204 and may convert it into a second signal associated with a first application such as application command 206. Signal converting system 200 may further comprise a captured movement sensing device such as an image sensor based human machine interface (IBHMI) 220 which may acquire a set of images, wherein substantially each image is associated with a different point in time and output captured motion output 204. Signal converting system 200 may further comprise an application such a gaming application associated with a computing platform such as computing platform 224. IBHMI 220 may include a digital camera, a video camera, a personal digital assistant, a cell phone and more devices adapted to sense and/or store movement and/or multimedia signals such as video, photographs and more.

It is understood that signal converting system 200 is essentially capable of the same functionalities as described with regard to signal converting module 100 of FIG. 1. Furthermore, in some embodiments, captured motion output 204 may essentially be the same as captured motion output 104, and/or captured motion output 110 both of FIG. 1. In some embodiments of the inventions, mapping module 202 may essentially be the same as mapping module 102 of FIG. 1. In some embodiments of the invention, application command 206 may essentially be the same as application command 106, 112 and/or 116 all of FIG. 1.

Optionally, according to some embodiments of the present invention, IBHMI 220, mapping module 202 and/or application 222 may be running on the same computing platform 224. Computing platform 224 may be a personal computer, a computer system, a server, an integrated circuit and more but not limited to these examples.

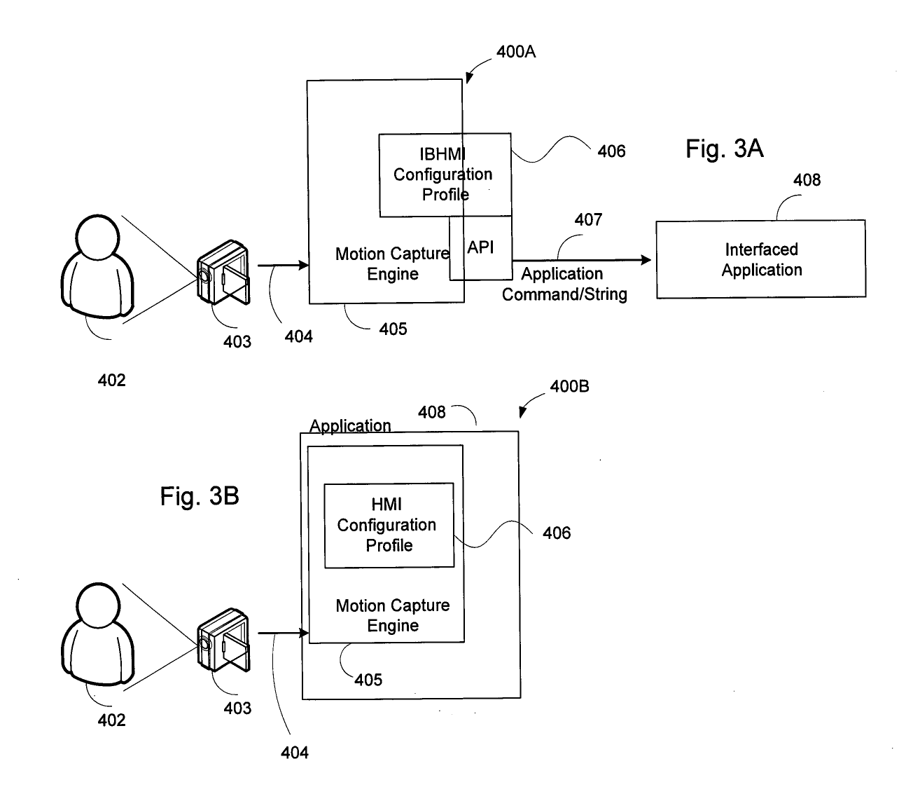

Turning now to FIGS. 3A and 3B, there are shown two separate implementations of embodiments of the present invention. According to the implementation of FIG. 3A, the mapping module is part of an API used by an application. The API is functionally associated with a motion capture engine (e.g. IBHMI) and an IBHMI configuration profile including a mapping table. FIG. 3B shows an implementation where the mapping table module and the mapping table are integrated with the application.

FIG. 3A shows a semi-pictorial diagram of an execution phase of a signal converting system, such as execution phase 400A. A motion such as motion 402 is captured by a motion sensor such as video camera 403. Captured motion output, such as output 404, which may represent a set of images, wherein substantially each image is associated with a different point in time such as a video, audio/video, multimedia signal and more. A motion capture engine, such as motion capture engine 405 then converts the captured motion output into a command associated with an application, such as application command 407. Motion capture engine 405 may use a IBHMI configuration profile such as IBHMI configuration profile 406 to configure, carry out or implement the conversion, wherein configured IBHMI defines the correlations between captured motion output 404 and application command 407 and may be embedded in Motion capture engine 405. Application command 407 is then transferred, through an API, as an input of an application or an interfaced computerized system such as interfaced application 408. Execution phase 400A carries out converting motion 402 into application command 407 and executing that command in interfaced application via motion capture engine by a predefined correlation defined in IBHMI configuration profile 406.

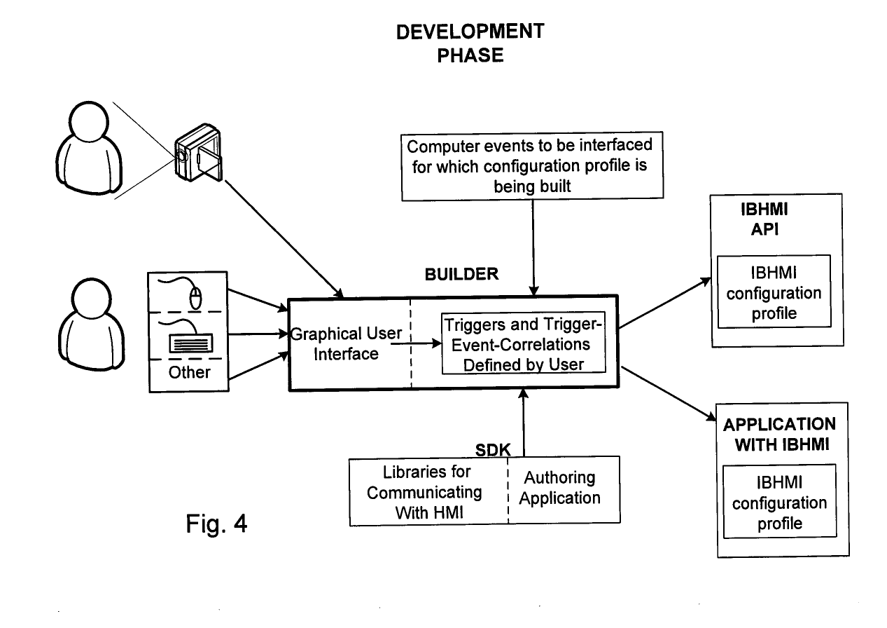

Turning now to FIG. 4, there is shown a symbolic block diagram of a IBHMI mapping table (e.g. configuration file) generator/builder. The generator may either generate a configuration file with a mapping table which may be used by an application through API including the mapping module and mapping table. According to further embodiments, the generator may link function/call libraries (i.e. SDK) with an application project and the application may be generated with the IBHMI and mapping module built in.

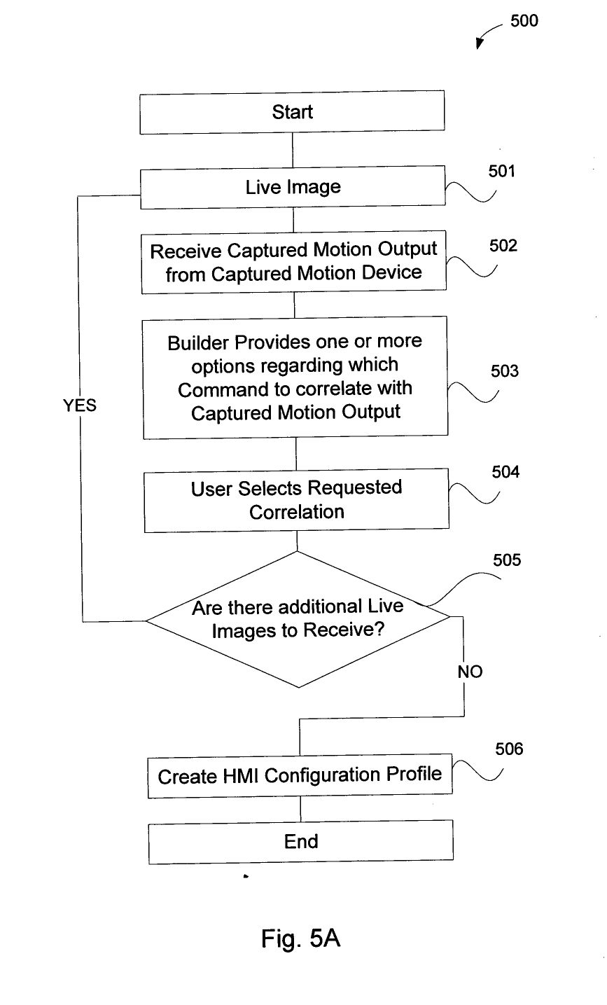

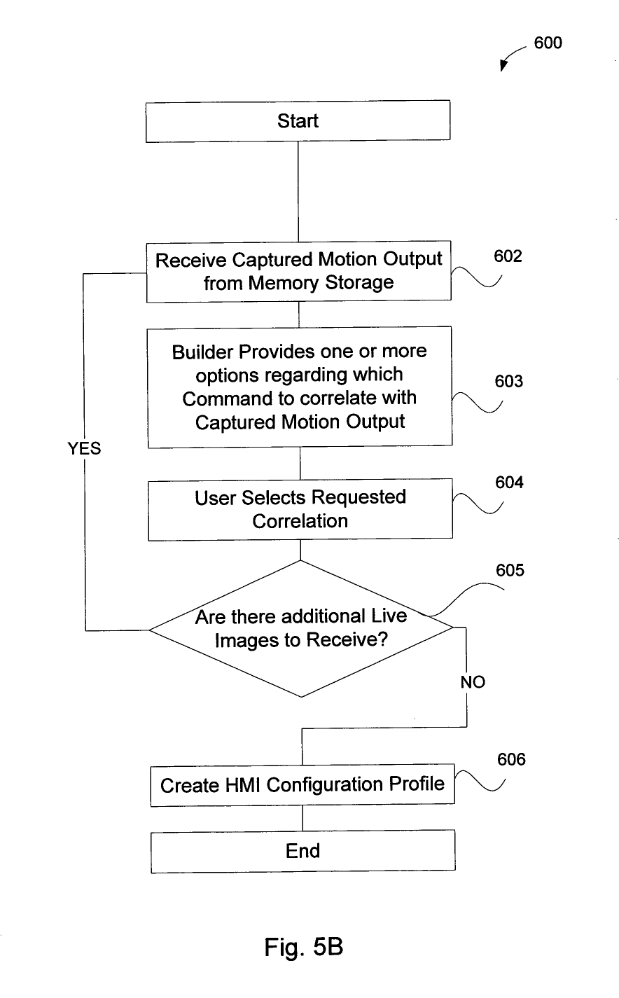

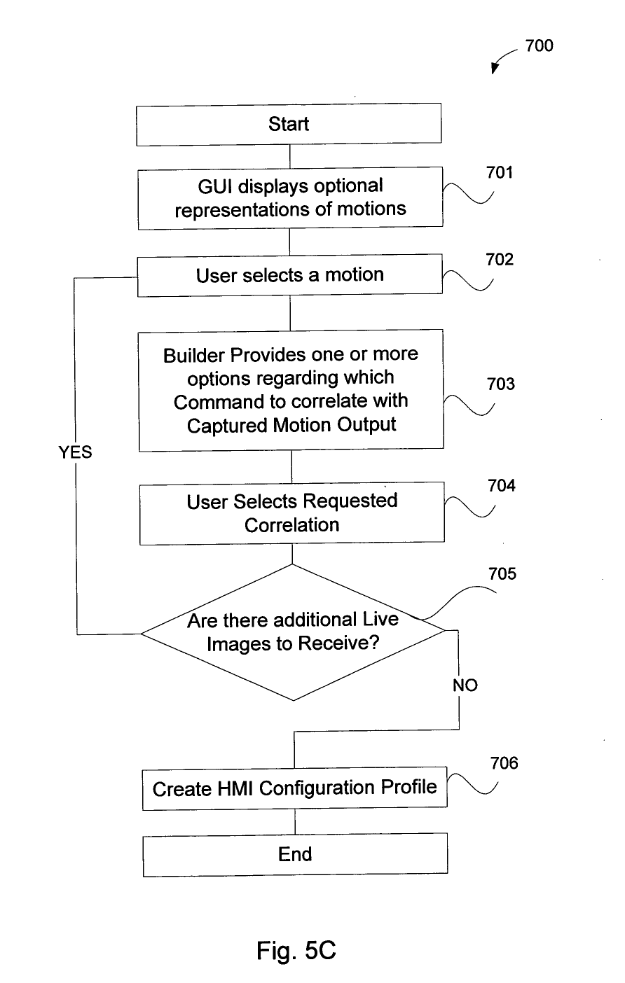

Turning now to FIG. 5A, there is shown a mapping table generator execution flow chart, as seen in flow chart 500. The mapping table generator may receive a given output from a captured motion device as seen in step 502 wherein the output may have, been depicted from a virtually simultaneous live image, as described in step 501. The table generator may then provide a user with one or more options regarding to which output string or command to associate with the given captured motion output, as described in step 503. In some embodiments of the invention, the given captured motion output may be generated by an IBHMI in response to a motion/position of a given type being detected in an image (e.g. video) acquired from an image sensor. The user may then select a requested correlation, as described by step 504. The mapping table generator may then either proceed to receive an additional captured motion or continue to a following step, as described in step 505. At the end of the process the table generator may create an HMI Configuration Profile, as described in step 506. HMI Configuration Profile described in step 506 may be part of a mapping module such as mapping module 102 or a mapping table such as mapping table 108 both of FIG. 1.

Turning now to FIG. 5B, there is shown a flow chart depicting a mapping table generator, as seen in flow chart 600. The mapping table generator may receive a given captured motion output from a storage memory, as seen in step 602. The storage memory may be part of a captured motion device, part of a computing platform, part of the mapping table generator and more but not limited to these examples. Furthermore, the storage memory described in step 602 may be a flash memory, hard drive or other but not limited to these examples. It is understood that steps 603-606 may essentially be the same as corresponding steps 503-506 of FIG. 5A described above.

Turning now to FIG. 5C, there is shown a flow chart depicting a mapping table generator, as seen in flow chart 700. The mapping table generator may have stored some or all of the possible IBHMI outputs, including a graphic representation of the motion/position associated with each output. A graphical user interface (GUI) of the mapping table generator may provide a user with a (optionally: computer generated) representation of a given motion/position type and an option to select an output string/command to map or otherwise associate with the given motion/position type, as shown in step 701. User may then select a motion/position to associate with an application command, as shown in step 702. It is understood that steps 703-706 may essentially be the same as corresponding steps 503-506 of FIG. 5A described above.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A signal converting module comprising:
a mapping module adapted to convert a first input associated with captured motion into a first output associated with a first application.

2. The module according to claim 1, wherein the captured motion is an output associated with an image sensor based human machine interface (IBHMI).

3. The module according to claim 1, wherein said mapping module is further adapted to convert a second input associated with captured motion into a second output associated with the second application.

4. The module according to claim 1, wherein said mapping module is adapted to convert a first input associated with captured motion into a second output associated with a second application.

5. The module according to claim 1, further comprising a mapping table wherein said mapping table consist of records selected from the group consisting of some or all of the possible inputs associated with captured motion, some or all of the possible outputs associated with a first application, and some or all of the outputs associated with a second application.

6. A signal converting system comprising:
an image sensor based human machine interfacing (IBHMI) output;
a first application associated with a computing platform;
and a mapping module adapted to convert said IBHMI output into a second output associated with said first application.

7. The system according to claim 6, wherein said IBHMI, first application and mapping module are adapted to run on said computing platform.

8. The system according to claim 6, wherein said mapping module is adapted to an interface device compatible with the computing platform on which the first application is running.

9. The system according to claim 6, wherein said mapping module is further adapted to convert said IBHMI output into a third output associated with a second application.

10. An image based human machine interface mapping table generator.

11. The generator according to claim 10, wherein said generator is adapted to generate a mapping data structure correlating input associated with captured motion to output associated with an application.

12. The generator according to claim 11, wherein said generator is adapted to generate a record in the mapping structure correlating a given gesture or position in a captured motion with a specific output signal.

13. The generator according to claim 12, wherein said generator is provided with the given gesture or position from a library of predefined gestures or positions.

14. The generator according to claim 12, wherein said generator is provided the given gesture or position from a captured training gesture or position.
